(19) United States
(12) Patent Application Publication
(10) Pub. No.: US 2025/0328260 A1
(43) Pub. Date: Oct. 23, 2025

(54) WRITE TEMPERATURE RECOVERY FROM A MEMORY SYSTEM

(71) Applicant: Micron Technology, Inc., Boise, ID (US)

(72) Inventors: Giuseppe Cariello, Boise, ID (US); Sebastiano Pischedda, Novi, MI (US)

(21) Appl. No.: 19/173,613

(22) Filed: Apr. 8, 2025

Related U.S. Application Data
(60) Provisional application No. 63/636,392, filed on Apr. 19, 2024.

(51) Int. Cl. G06F 3/06

(52) U.S. Cl. CPC G06F 3/0619; G06F 3/0653; G06F 3/0659

(57) ABSTRACT

Methods, systems, and devices for write temperature recovery from a memory system are described. A memory system may receive a command to provide write temperature information associated with data written to the one or more memory devices. The memory system may read, from the one or more memory devices based on the command, a write temperature indicative of a temperature of the memory system at a time of writing a subset of the data. The memory system may read, based on transmitting the write temperature to a host system, one or more subsets of the data.

### CROSS REFERENCE

The present Application for Patent claims priority to U.S. Patent Application No. 63/636,392 by Cariello et al., entitled “WRITE TEMPERATURE RECOVERY FROM A MEMORY SYSTEM,” filed Apr. 19, 2024, which is assigned to the assignee hereof, and which is expressly incorporated by reference in its entirety herein.

### TECHNICAL FIELD

The following relates to one or more systems for memory, including write temperature recovery from a memory system.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states if disconnected from an external power source.

### BRIEF DESCRIPTION OF THE DRAWINGS

FIG. 1 shows an example of a system that supports write temperature recovery from a memory system in accordance with examples as disclosed herein.

FIG. 2 shows an example of a system that supports write temperature recovery from a memory system in accordance with examples as disclosed herein.

FIG. 3 shows an example of a process flow that supports write temperature recovery from a memory system in accordance with examples as disclosed herein.

FIG. 4 shows a block diagram of a memory system that supports write temperature recovery in accordance with examples as disclosed herein.

FIG. 5 shows a block diagram of a host system that supports write temperature recovery from a memory system in accordance with examples as disclosed herein.

FIGS. 6 and 7 show flowcharts illustrating a method or methods that support write temperature recovery from a memory system in accordance with examples as disclosed herein.

### DETAILED DESCRIPTION

A memory system may be used to store data that is desirable to recover. For example, after an event (e.g., a crash, a catastrophic event, a system failure or problem) it may be desirable to recover data (e.g., black box data) collected by one or more sensors and camera(s) for example, related to a vehicle that includes the memory system (e.g., so that information about the crash, failure, or problem can be determined). But recovering the data-in a process which may be referred to as a forensic data recover procedure-may be challenging if the memory system has a different temperature during retrieval of the data relative to the temperature during writing of the data, among other differences. For example, the error rate associated with recovering the data may increase with larger differences in the write temperature and read temperature, where the write temperature for a set of data is the temperature of the memory system at a time of writing the set of data, and where the read temperature for a set of data is the temperature of the memory system at a time of reading the set of data.

According to the techniques described herein, a system may improve the recovery of data (e.g., black box data) by having a memory system provide a write temperature for the data, for example, to a host system so that the host system can adjust the read temperature of the memory system to be within a threshold range of the write temperature. For example, the host system may adjust a temperature setting associated with the memory system (e.g., the temperature setting of a temperature control device) so that the read temperature of the memory system is within the threshold range of the write temperature. Once the read temperature of the memory system is within the threshold range of the write temperature (and/or in response to some other trigger condition), the memory system may read the data and, in some examples, transmit the data (e.g., to the host system).

In addition to applicability in memory systems as described herein, techniques for write temperature recovery may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by improving the reliability of recovered data, which may improve user experience and lead to more accurate assessments and operation by one or more systems, among other benefits.

In addition to applicability in memory systems as described herein, techniques for write temperature recovery may be generally implemented to improve the sustainability of various electronic devices and systems. As the use of electronic devices has become even more widespread, the quantity of energy used and harmful emissions associated with production of electronic devices and device operation has increased. Further, the amount of waste (e.g., electronic waste) associated with disposal of electronic devices may also pose environmental concerns. Implementing the techniques described herein may improve the impact related to electronic devices by improving and/or increasing access to data, which may reduce the resources used to recover the data, among other benefits.

Features of the disclosure are illustrated and described in the context of systems, devices, and circuits. Features of the disclosure are further illustrated and described in the context of a system, a process flow, device diagrams, and flowcharts.

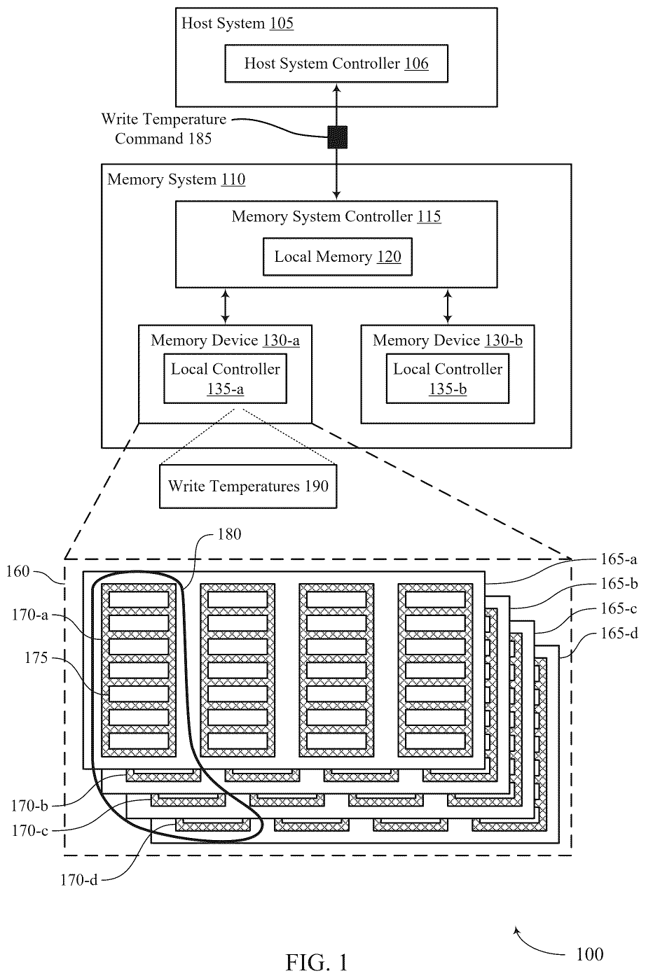

FIG. 1 shows an example of a system 100 that supports write temperature recovery from a memory system in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, L2P mapping tables may be maintained and data may be marked as valid or invalid at the page level of granularity, and a page 175 may contain valid data, invalid data, or no data. Invalid data may be data that is outdated, which may be due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has never been written to or that has been erased.

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

To read data stored in the memory system 110 (e.g., as part of a forensic data recover procedure to recover black box data from one or more sensors or cameras coupled with a vehicle), the host system 105 may transmit a read command for the data to the memory system 110. The memory system 110 may attempt to read the data, but if the read temperature for the data is sufficiently different from the write temperature for the data, the data may be read with one or more errors that decrease the reliability of the data. According to the techniques described herein, the host system 105 may improve the reliability of the data by adjusting the temperature of the memory system 110 (e.g., so that the read temperature is closer to the write temperature during a subsequent read operation). The host system 105 may adjust the temperature of the memory system 110 based on (e.g., as a function of) a write temperature (associated with the data) provided by the memory system 110. Such a technique may allow the host system 105 to recover the data without using a trial-and-error process to determine the read temperature, which may risk further disturbing the data.

To facilitate such a technique, the memory system 110 may (e.g., via the memory system controller 140) track the write temperatures 190 for subsets of the data and store the write temperatures 190 in one or more of the memory devices 145. In a first example, the memory system 110 may store the write temperature for a subset (e.g., page) of the data in the same block or page as the subset of the data. In a second example, the memory system 110 may store the average write temperatures for different subsets (e.g., page ranges) of the data in a table of the memory device(s) 145. The memory system 110 may provide a write temperature associated with the data to the host system 105, which may request the write temperature via the write temperature command 185. The host system (e.g., via the host system controller 106) may use the write temperature as a basis to adjust a temperature setting for the memory system 110 so that the reliability of data read from the memory device(s) 145 (e.g., during a forensic data recovery procedure or other data retrieval procedure) is increased.

The system 100 may include any quantity of non-transitory computer readable media that support write temperature recovery from a memory system. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

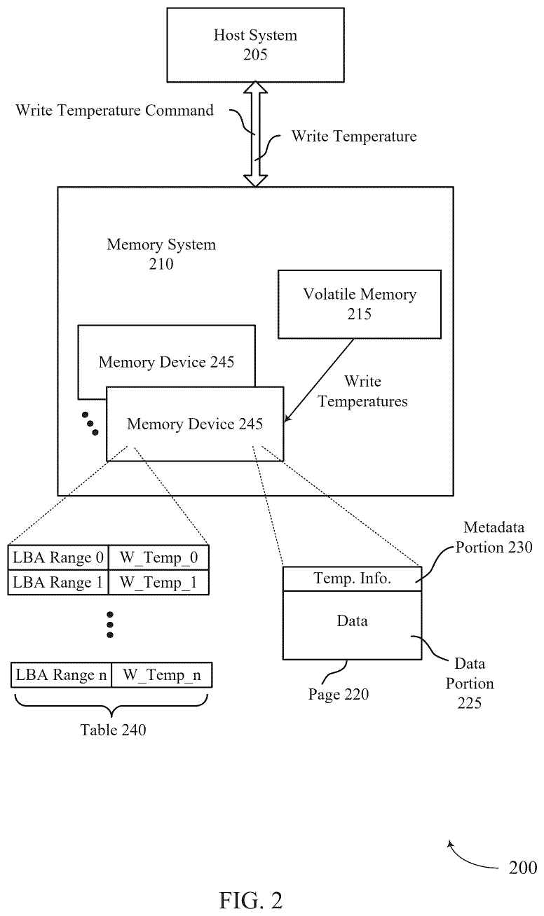

FIG. 2 shows an example of a system 200 that supports write temperature recovery from a memory system in accordance with examples as disclosed herein. The system 200 may be an example of the system 100. The system 200 may include a host system 205, which may be an example of the host system 105 as described with reference to FIG. 1, and a memory system 210, which may be an example of the memory system 110 as described with reference to FIG. 1.

The memory system 210 may write data (e.g., black box data) to the one or more memory devices 245. For example, the memory system 210 may write subsets of the data to pages 220 of the memory devices 245. A page 220 may be assigned a physical address (e.g., a physical page address (PPA)) which may be mapped to one or more logical block addresses (LBAs). Additionally, the memory system 210 may write metadata associated with the data, such as write temperatures to the one or more memory devices 245. One or more write temperatures may be referred to as write information. The memory system 210 may determine the write temperature for a subset of the data by measuring the temperature of the memory system 210 at a time of writing the subset of the data. In some examples, the write temperatures for the data may be protected with a first error protection scheme (e.g., a first error correction code, a first redundancy scheme) that is capable of detecting and correcting higher quantities of errors than a second error protection scheme (e.g., a second error correction code, a second redundancy scheme) that is used to protect the data. Such variation in error protection schemes may improve the reliability of the write temperatures relative to the data.

In a first example, the memory system 210 may write the write temperature for a subset of the data in the same location (e.g., block, page) as the subset. For example, if the subset of the data is stored in data portion 225 of the page 220, the memory system 210 may write the write temperature to the metadata portion 230, which may not be directly addressable by the host system 205. Thus, in the first example, the write temperature for a subset of data may be co-located with the subset of the data (e.g., stored in the same block as the subset of the data, stored in the same page as the subset of the data). Because write temperature information is significantly smaller than associated data, redundancy and other mechanisms, such as Gray codes, might be utilized to help the retrieval of write temperature even when associated data are not correctable.

In the first example, the host system 205 may obtain write information for the data by transmitting a write temperature command for the memory system to provide the write information. The write temperature command may include an indication of a first logical address associated with a subset of the data. The first logical address may be mapped to a physical address for a set of memory cells that store a subset of the data. The memory system 210 may attempt to read a first write temperature associated with the first logical address and, if first write temperature is recoverable (e.g., has fewer than a threshold quantity of errors), the memory system 210 may transmit the first write temperature to the host system 205 in response to the write temperature command.

However, if the write temperature is unrecoverable (e.g., has more than a threshold quantity of errors), the memory system 210 may read a second write temperature associated with a second logical address that satisfies one or more substitution conditions for transmitting the second write temperature in place of the first write temperature. In such examples, the memory system 210 may transmit the second write temperature to the host system 205 in response to the write temperature command (and in place of the first write temperature associated with the first logical address). Transmission of the second write temperature in place of the first write temperature may be permissible because the temperature of the memory system may fluctuate relatively slowly compared to the cadence of writing the data, and thus the second write temperature may be sufficiently similar (e.g., within a threshold range) to the first write temperature for the purposes of data recovery (providing one or more substitution conditions are met to ensure sufficient similarity).

In some examples, a substitution condition for transmitting the second write temperature associated with the second logical address in place of the first write temperature associated with the first logical address may be that the second logical address is included in a range of logical addresses that are associated with the data. Such a substitution condition may be implemented if the data is written in a sequential manner such that sequentially received subsets of the data are written to sequentially-indexed logical addresses. For similar reasons, in some examples, a substitution condition may be that the second logical address is within a threshold range, index-wise, of the second logical address.

In some examples, a substitution condition may be that the second physical address associated with the second logical address has an assigned performance level (e.g., reliability level) that is higher than a threshold level (and higher than the performance level assigned to the first physical address associated with the first logical address). Some physical locations in a block may be known to the memory system 210 as being intrinsically more reliable than others (e.g., due to systematic disparity in the fabrication process) and these physical locations may be assigned reliability levels that are indicative of such. Additionally or alternatively, some physical locations may be assigned high reliability levels (relative to other physical locations) if those physical locations support a better error detection/correction capability (e.g., error correction code scheme, redundancy scheme) relative to the other physical locations. A reliability level may represent or be indicative of an error rate or other error metric associated with a physical address, physical location, or set of memory cells.

In some examples, a substitution condition may be based on the physical location of the first physical address associated with the first logical address. For instance, a substitute condition may be that the second logical address is associated with a second physical address that is sufficiently close to (e.g., within a threshold distance of) the first physical address associated with the first logical address. Such a condition may be implemented even if the data is not written sequentially because the write temperatures are close enough timewise during the writing which translates to physical proximity of the data. So, if the memory system 210 is unable to read some location (e.g., the first physical address associated with the first logical address), the memory system 210 may search surrounding physical locations for a readable write temperature.

In some examples, a substitution condition may be that the second logical address is mapped to memory cells that are in a particular physical location (e.g., a high reliability location) on the memory die.

In a second example, the memory system 210 may determine an average write temperature for a subset of the data that satisfies a threshold size and may write the average write temperature for that subset to a table (e.g., a firmware table) of a memory device 245. For example, the memory system 210 may write the average write temperature for a subset of the data to table 240, which may include the average write temperatures (e.g., W_Temp_0 through W_Temp_n) of different subsets of the data. The threshold size may be related to (e.g., based on, a factor of, equal to) the checkpoint size, which may refer to the amount of data that can be written to the memory device(s) 245 before control information (e.g., L2P information) for the data is flushed (e.g., copied) from the volatile memory 215 to the memory device(s) 245. Thus, a subset of data that satisfies the threshold size may span (e.g., be written to memory cells mapped to) a range of logical addresses. Accordingly, the table 240 may include the average write temperatures associated with ranges of logical addresses (e.g., LBA range 0 through LBA range n).

Thus, in the second example, the write temperature for a subset of data (which may represent the average write temperature for the subset of data) may be stored separately (e.g., in a different page, in a different block) from the subset of the data. In some examples, the write temperatures for the data may be written to blocks with higher reliability than the blocks to which the data is written (e.g., the write temperatures in table 240 may be written to SLC blocks whereas the corresponding data may be written to TLC blocks).

To determine the average write temperature for the subset of data, the memory system 210 may track the respective write temperatures for individual pages of the data and perform a statistical computation on the write temperatures. The memory system 210 may monitor the write temperatures for the subset of data and may discard outlier write temperatures (e.g., write temperatures for sequential logical addresses that vary by a threshold amount) to ensure accuracy of the average temperature.

In the second example, the host system 205 may obtain write information for the data by transmitting a write temperature command for the memory system to provide the write information. The write temperature command may include an indication of a first logical address associated with a subset of the data. The first logical address may be mapped to a first physical address for a set of memory cells that store some of the data. However, the write temperature associated with the first logical address (e.g., the average write temperature for the logical address range that includes the first logical address) may be stored in table 240, and thus may be written to a second physical address that is different than the first physical address. Accordingly, the memory system 210 may reference the table 240 for the logical address range that includes the first logical address and may read the associated write temperature from the table 240. The memory system 210 may then transmit the write temperature (e.g., the average write temperature) to the host system 205 in response to the write temperature command.

Regardless of how the memory system 210 stores and retrieves the write temperature information, the memory system 210 may respond to the write temperature command for write information associated with the data by transmitting a write temperature that is associated with a subset of the data. In the first example, the transmitted write temperature may be a first write temperature associated with a first logical address indicated by the host system 205 (e.g., if the first write temperature is recoverable) or the transmitted write temperature may be a second write temperature associated with a second logical address (e.g., if the first write temperature is unrecoverable and the second logical address satisfies one or more substitution conditions). In the second example, the transmitted write temperature may be a first write temperature associated with a first logical address indicated by the host system 205 (e.g., the first write temperature may be the average write temperature mapped to the logical address range that includes the first logical address).

The host system 205 may use the write temperature provided by the memory system 210 to adjust a temperature setting associated with the memory system 210. For example, the host system 205 may adjust the temperature setting of a temperature control device that controls the temperature of the memory system 210. The temperature control device may be part of the memory system 210 or may be an external device that is coupled with the memory system 210 or the host system 205. The host system 205 may determine the temperature setting for the memory system 210 based on (e.g., as a function of) the difference between the current temperature of the memory system 210 and the write temperature. The current temperature of the memory system 210 may be estimated by the host system 205 based on the current temperature of the host system 205 or may be provided by the memory system 210 (e.g., in response to the write temperature command, in response to a separate request).

After adjusting the temperature setting, the host system 205 may monitor the current temperature of the memory system 210. The host system 205 may transmit one or more read commands for the data based on (e.g., in response to) determining that the current temperature has satisfied a threshold associated with the temperature setting or is within a threshold range of the write temperature. The memory system 210 may read and transmit one or more subsets of the data based on (e.g., in response to) the one or more read commands.

Alternatively, the host system 205 may transmit to the memory system 210 an indication that the current temperature has satisfied a threshold associated with the temperature setting or an indication that the current temperature is within a threshold range of the write temperature. In such examples, the memory system 210 may read and transmit one or more subsets of the data based on (e.g., in response to) the indication(s). In some examples, the host system 205 may transmit to the memory system 210 an indication that the host system 205 has adjusted the temperature setting, an indication of the threshold, or an indication of the threshold range, or a combination thereof. In such examples, the memory system 210 may read and transmit the one or more subset of the data based on (e.g., in response to) determining that the current temperature of the memory system 210 satisfies the threshold or is within the threshold range. Additionally or alternatively, the memory system 210 may transmit an indication to the host system 205 that the current temperature of the memory system 210 satisfies the threshold or is within the threshold range (e.g., so that the host system 205 can send a read command or prepare for the data).

In some examples, the memory system 210 may delay one or more procedures until after the current temperature of the memory system 210 has been adjusted. For example, the memory system 210 may delay an asynchronous power loss (APL) scan in which the memory system 210 rebuilds data (e.g., reads data and corrects any errors before writing the data back to memory) so that the host system 205 can continue writing to the memory system 210. The memory system 210 may determine to perform a APL scan based on (e.g., in response to) determining that the memory system 210 unexpectedly lost power. However, performing the APL scan for data at a temperature sufficiently different than the write temperature for the data may increase the quantity of errors in the data. To prevent such a scenario, the memory system 210 may delay the APL scan (e.g., based on receiving the write temperature command) until after the current temperature of the memory system 210 is sufficiently close to (e.g., within a threshold range) the write temperature.

Thus, the system 200 may compensate for extreme write temperatures, which may improve the reliability of a forensic data recovery procedure or other data retrieval procedure.

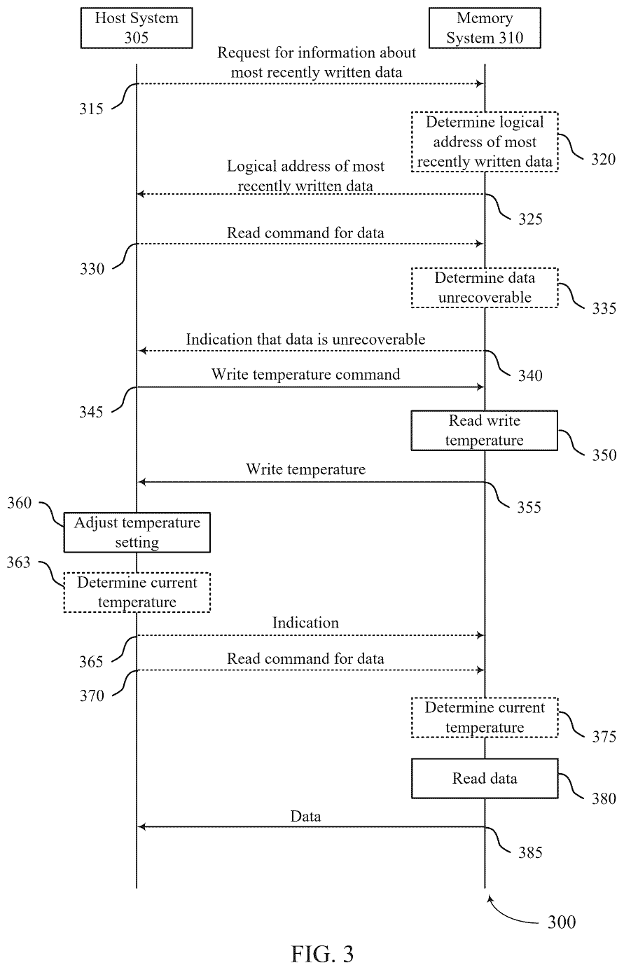

FIG. 3 shows an example of a process flow 300 that supports write temperature recovery from a memory system in accordance with examples as disclosed herein. The process flow 300 may be implemented by a host system 305 (e.g., via one or more controllers such as the host system controller 106), which may be an example of a host system 105 or a host system 205, and a memory system 310 (e.g., via one or more controllers such as the memory system controller 140), which may be an example of a memory system 110 or a memory system 210.

At 315, a system or device, such as the host system 305, may transmit a request for information about most-recently written data. For example, the host system 305 may transmit a request for the memory system 310 to provide the logical address(es) of one or more most-recently written subsets of a set of data (e.g., black box data). At 320, a system or device, such as the memory system 310, may determine the logical address(es) of one or more most-recently written subsets of the set of data. At 325, a system or device, such as the memory system 310, may transmit (e.g., in response to the request at 315) an indication of the logical address(es) of one or more most-recently written subsets of the set of data. In some examples, the indication may be an offset (e.g., in gigabytes) relative to a starting address for the set of data.

At 330, a system or device, such as the host system 305, may transmit a read command for a subset of the set of data. The read command may be associated with a logical address that may be, or be based on, the logical address of the most-recently written subset of the set of data. At 335, a system or device, such as the memory system 310, may (e.g., in response to the read command at 330) determine that the subset of the set of data is unrecoverable. For example, the memory system 310 may read the subset of the set of data from memory and determine that the subset of the set of data has a threshold quantity of errors. At 340, a system or device, such as the memory system 310, may transmit an indication that the subset of the set of data is unrecoverable.

At 345, a system or device, such as the host system 305 may transmit a write temperature command. The write temperature command may be a vendor unique (VU) command or a standardized command. In some examples, the host system 305 may transmit the write temperature command in response to the indication at 340. In some examples, the host system 305 may transmit the write temperature command based on (e.g., due to) determining to perform a data recovery procedure such as a forensic data recovery procedure. In some examples, the write temperature command may include, or be associated with, a first logical address that is associated with the set of data (e.g., a logical address that is mapped to a physical address of memory cells that store a first subset of the set of data). In some examples, the first logical address may be or be based on the logical address of the most-recently written subset of the set of data.

At 350, a system or device, such as the memory system 310, may (e.g., in response to the write temperature command) read a write temperature from memory.

In a first example (e.g., where write information for a subset of the set of data is written to the same location as the subset of the set of data), the memory system 310 may read the first write temperature from memory, where the first write temperature is associated with the first logical address. If the first write temperature is recoverable (e.g., has less than a threshold quantity of errors), a system or device, such as the memory system 310, may transmit the first write temperature to the host system 305 at 355. If the first write temperature is unrecoverable (e.g., has more than a threshold quantity of errors), the memory system 310 may scan other memory locations associated with the set of data for a recoverable write temperature. For example, the memory system 310 may read a second write temperature associated with a second logical address that satisfies a substitution condition for replacing the first write temperature with the second write temperature. In such an example, a system or device, such as the memory system 310, may transmit the second write temperature at 355 in place of the first write temperature. The memory system 310 may determine whether the second logical address satisfies the substation condition based on the second logical address being within a threshold range (e.g., index-wise) of the first logical address, based on a performance level (e.g., reliability level) assigned to the first physical address (or memory cells) associated with the first logical address, based on a physical location of memory cells associated with the first logical address, or any combination thereof.

In a second example (e.g., where write information for a subset of the set of data is written to a table in a different location than the subset of the set of data), the memory system 310 may read the first write temperature from memory. For example, the memory system 310 may identify the table (e.g., the table 240) with the logical address range that includes the first logical address and may read the first write temperature (which may represent the average write temperature of the logical address range) from the table. Accordingly, the memory system 310 may transmit the first write temperature at 355.

At 360, a system or device, such as the host system 305, may adjust a temperature setting associated with the memory system 310. For example, the host system 305 may adjust the temperature setting of a temperature control device that is configured to change the temperature of the memory system 310. The host system 305 may adjust the temperature setting based on the write temperature provided by the memory system at 310. For example, the host system 305 may determine a difference between the write temperature and a current temperature of the memory system 310 and may adjust the temperature setting based on the difference. The adjusted temperature setting may correspond to a threshold temperature at which the memory system 310 is to read the set of data.

At 363, the host system 305 may determine that the current temperature of the memory system 310 satisfies the threshold temperature. In some examples, the host system 370 may determine that the current temperature of the memory system 310 satisfies the threshold temperature based on (e.g., in response to) an indication from the memory system 310. In some examples, the host system 370 may determine that the current temperature of the memory system 310 satisfies the threshold temperature based on (e.g., in response to) a current temperature of the host system 305 or a temperature reported by the temperature control device.

At 365, a system or device, such as the host system 305, may transmit an indication to the memory system 310. In some examples, the indication may be that the current temperature of the memory system 310 satisfies (e.g., is within a threshold range of) the threshold temperature. In some examples, the indication may be that the host system 305 has adjusted the temperature setting. In some examples, the indication may be of the threshold temperature.

At 370, a system or device, such as the host system 370, may transmit one or more read commands for one or more subsets of the set of data. The host system 370 may transmit the read command in response to determining that the current temperature of the memory system 310 satisfies the threshold temperature.

At 375, a system or device, such as the memory system 310, may determine the current temperature of the memory system. In some examples, the memory system 310 may also determine that the current temperature satisfies the threshold temperature. At 380, a system or device, such as the memory system 310, may read the one or more subsets of the set of data. The memory system 310 may system 310 may read the one or more subsets of the set of data in response to the read command(s) at 370, in which case the one or more subsets of the set of data may associated with logical addresses indicated by the read command(s) at 370. Additionally or alternatively, the memory system 310 may read the one or more subsets of the set of data in response to determining that the current temperature of the memory system 310 satisfies the threshold temperature.

At 385, a system or device, such as the memory system 310, may transmit the one or more subsets of the set of data to the host system 305.

Thus, the host system 305 and the memory system 310 may work together to enable recovery of data at a read temperature that reduces errors, which may improve the reliability of the recovered data.

Aspects of the process flow 300 may be implemented by one or more controllers, among other components. Additionally or alternatively, aspects of the process flow 300 may be implemented as instructions stored in one or more memories (e.g., firmware stored in one or more memories coupled with the host system 305 and the memory system 310). For example, the instructions, when executed by one or more controllers (e.g., the host system controller 106, the memory system controller 140), may cause the one or more controllers (or a device or a system) to perform the operations of the process flow 300.

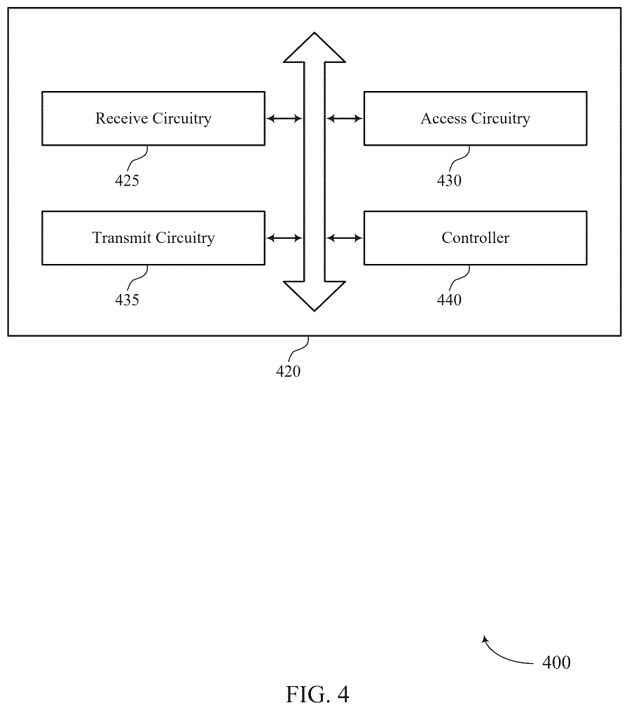

FIG. 4 shows a block diagram 400 of a memory system 420 that supports write temperature recovery from a memory system in accordance with examples as disclosed herein. The memory system 420 may be an example of aspects of a memory system as described with reference to FIGS. 1 through 3. The memory system 420, or various components thereof, may be an example of means for performing various aspects of write temperature recovery from a memory system as described herein. For example, the memory system 420 may include a receive circuitry 425, an access circuitry 430, a transmit circuitry 435, a controller 440, or any combination thereof. Each of these components, or components of subcomponents thereof (e.g., one or more processors, one or more memories), may communicate, directly or indirectly, with one another (e.g., via one or more buses).

The receive circuitry 425 may be configured as or otherwise support a means for receiving a command to provide write temperature information associated with data written to the one or more memory devices. The access circuitry 430 may be configured as or otherwise support a means for reading, from the one or more memory devices based at least in part on the command, a write temperature indicative of a temperature of the memory system at a time of writing a subset of the data. In some examples, the access circuitry 430 may be configured as or otherwise support a means for reading, based at least in part on transmitting the write temperature to a host system, one or more subsets of the data.

In some examples, the receive circuitry 425 may be configured as or otherwise support a means for receiving a read command for one or more subsets of the data. In some examples, the transmit circuitry 435 may be configured as or otherwise support a means for transmitting, based at least in part on receiving the read command, an indication that the one or more subsets of the data is unrecoverable at a current temperature of the memory system, where the command to provide write temperature information is received based at least in part on the indication.

In some examples, the controller 440 may be configured as or otherwise support a means for determining whether a current temperature of the memory system is within a threshold range of the write temperature, where the one or more subsets of the data is read based at least in part on determining that the current temperature of the memory system is within the threshold range of the write temperature.

In some examples, the receive circuitry 425 may be configured as or otherwise support a means for receiving, from the host system, an indication that the host system has adjusted a temperature setting associated with the memory system, where the current temperature is determined based at least in part on the indication.

In some examples, the receive circuitry 425 may be configured as or otherwise support a means for receiving, from the host system, an indication that the current temperature of the memory system is within the threshold range of the write temperature, where determining that the current temperature of the memory system is within the threshold range is based at least in part on the indication.

In some examples, receive a read command for the one or more subsets of the data based at least in part on transmitting the write temperature, where the one or more subsets of the data is read based at least in part on the read command.

In some examples, the controller 440 may be configured as or otherwise support a means for determining a first logical address associated with a most-recently written subset of the data. In some examples, the transmit circuitry 435 may be configured as or otherwise support a means for transmitting an indication of the first logical address associated with the most-recently written subset of the data, where the read command is received based at least in part on transmitting the indication.

In some examples, the data includes black box data received from one or more vehicle sensors. In some examples, the read command is part of a forensic data recovery procedure to recover the black box data.

In some examples, the write temperature is associated with a first logical address and the command is associated with a second logical address, and the access circuitry 430 may be configured as or otherwise support a means for reading the write temperature from memory cells associated with the first logical address based at least in part on the first logical address satisfying a substitution condition for returning the write temperature to the host system in place of a second write temperature associated with the second logical address.

In some examples, the controller 440 may be configured as or otherwise support a means for determining whether the second write temperature is unrecoverable, where the write temperature is read based at least in part on determining that the second write temperature is unrecoverable.

In some examples, the controller 440 may be configured as or otherwise support a means for determining that the first logical address satisfies the substitution condition based at least in part on the first logical address being within a threshold range, index-wise, of the second logical address.

In some examples, the controller 440 may be configured as or otherwise support a means for determining that the first logical address satisfies the substitution condition based at least in part on a performance level assigned to a first physical address associated with the first logical address.

In some examples, the controller 440 may be configured as or otherwise support a means for determining that the first logical address satisfies the substitution condition based at least in part on a physical location of memory cells associated with the first logical address.

In some examples, the command indicates a first logical address, and the controller 440 may be configured as or otherwise support a means for determining a table of the one or more memory devices that stores write temperatures representative of average write temperatures for different subsets of the data. In some examples, the command indicates a first logical address, and the access circuitry 430 may be configured as or otherwise support a means for reading the write temperature from the table based at least in part on the write temperature being associated with a range of logical addresses that includes the first logical address.

In some examples, the access circuitry 430 may be configured as or otherwise support a means for writing the subset of the data to the one or more memory devices, where the command to provide the write temperature information is received after writing the subset of the data. In some examples, the controller 440 may be configured as or otherwise support a means for determining an average write temperature for the subset of the data based at least in part on writing the subset of the data and based at least in part on a size of the subset of the data satisfying a threshold. In some examples, the access circuitry 430 may be configured as or otherwise support a means for writing the write temperature to the table of the one or more memory devices, where the write temperature includes the average write temperature.

In some examples, the command is associated with a first logical address, and the controller 440 may be configured as or otherwise support a means for determining, based at least in part on the first logical address, a table in the one or more memory devices that stores the write temperature associated with the first logical address, where the write temperature is read from the table.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

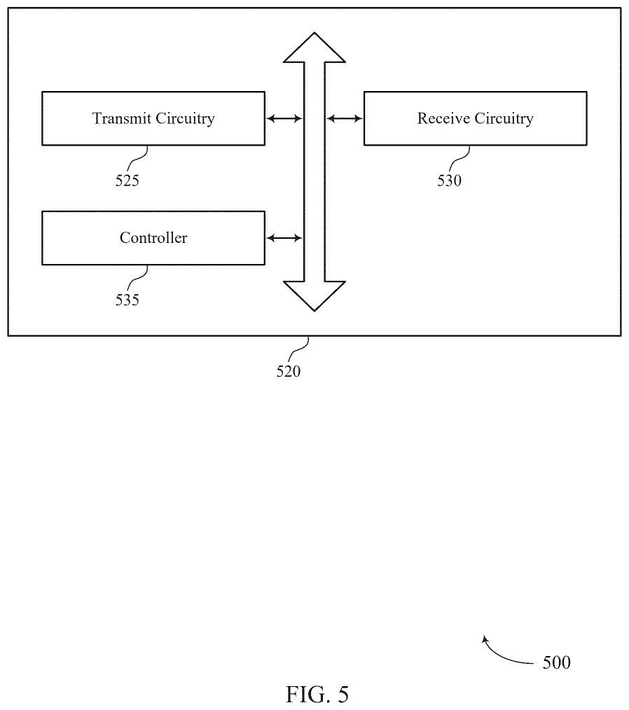

FIG. 5 shows a block diagram 500 of a host system 520 that supports write temperature recovery from a memory system in accordance with examples as disclosed herein. The host system 520 may be an example of aspects of a host system as described with reference to FIGS. 1 through 3. The host system 520, or various components thereof, may be an example of means for performing various aspects of write temperature recovery from a memory system as described herein. For example, the host system 520 may include a transmit circuitry 525, a receive circuitry 530, a controller 535, or any combination thereof. Each of these components, or components of subcomponents thereof (e.g., one or more processors, one or more memories), may communicate, directly or indirectly, with one another (e.g., via one or more buses).

The transmit circuitry 525 may be configured as or otherwise support a means for transmitting a command for the memory system to provide write temperature information associated with a data written to one or more memory devices of the memory system. The receive circuitry 530 may be configured as or otherwise support a means for receiving, based at least in part on transmitting the command, a write temperature indicative of a temperature of the memory system at a time of writing a subset of the data. The controller 535 may be configured as or otherwise support a means for adjusting a temperature setting associated with the memory system based at least in part on a difference between the write temperature and a current temperature of the memory system.

In some examples, the receive circuitry 530 may be configured as or otherwise support a means for receiving one or more subsets of the data based at least in part on receiving the write temperature.

In some examples, the transmit circuitry 525 may be configured as or otherwise support a means for transmitting an indication of a threshold temperature associated with the temperature setting, where the one or more subsets of the data is received based at least in part on indication.

In some examples, the transmit circuitry 525 may be configured as or otherwise support a means for transmitting an indication that the host system has adjusted the temperature setting associated with the memory system, where the one or more subsets of the data is received based at least in part on the indication.

In some examples, the controller 535 may be configured as or otherwise support a means for determining, after adjusting the temperature setting, that the current temperature of the memory system is within a threshold range of the write temperature. In some examples, the transmit circuitry 525 may be configured as or otherwise support a means for transmitting a read command for the one or more subsets of the data based at least in part on determining that the current temperature is within the threshold range, where the one or more subsets of the data is received based at least in part on the read command.

In some examples, the controller 535 may be configured as or otherwise support a means for determining, after adjusting the temperature setting, that the current temperature of the memory system is within a threshold range of the write temperature. In some examples, the transmit circuitry 525 may be configured as or otherwise support a means for transmitting an indication that the current temperature of the memory system is within the threshold range of the write temperature, where the one or more subsets of the data is received based at least in part on the indication.

In some examples, the transmit circuitry 525 may be configured as or otherwise support a means for transmitting a read command for one or more subsets of the data. In some examples, the receive circuitry 530 may be configured as or otherwise support a means for receiving, based at least in part on transmitting the read command, an indication that the one or more subsets of the data is unrecoverable at the current temperature of the memory system, where the command for the memory system to provide write temperature information is transmitted based at least in part on the indication.

In some examples, the write temperature is associated with a first logical address and the command is associated with a second logical address.

In some examples, the described functionality of the host system 520, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the host system 520, or various components thereof, may be implemented at least in part by instructions (e.g., stored in memory, non-transitory computer-readable medium) executable by such at least one processor.

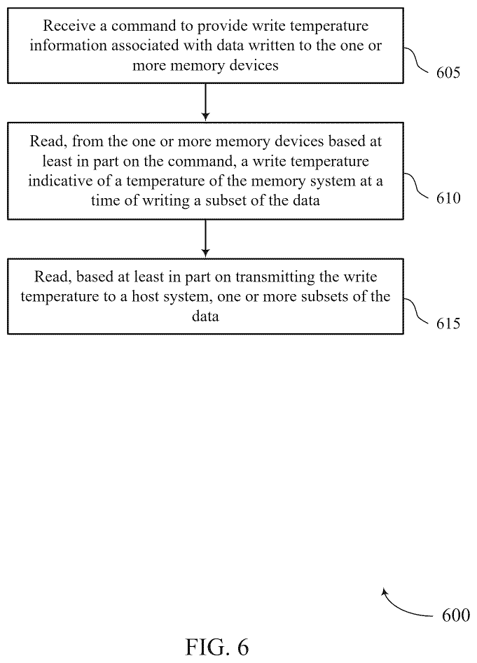

FIG. 6 shows a flowchart illustrating a method 600 that supports write temperature recovery from a memory system in accordance with examples as disclosed herein. The operations of method 600 may be implemented by a memory system or its components as described herein. For example, the operations of method 600 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 605, the method may include receiving a command to provide write temperature information associated with data written to the one or more memory devices. In some examples, aspects of the operations of 605 may be performed by a receive circuitry 425 as described with reference to FIG. 4.

At 610, the method may include reading, from the one or more memory devices based at least in part on the command, a write temperature indicative of a temperature of the memory system at a time of writing a subset of the data. In some examples, aspects of the operations of 610 may be performed by an access circuitry 430 as described with reference to FIG. 4.

At 615, the method may include reading, based at least in part on transmitting the write temperature to a host system, one or more subsets of the data. In some examples, aspects of the operations of 615 may be performed by an access circuitry 430 as described with reference to FIG. 4.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving a command to provide write temperature information associated with data written to the one or more memory devices; reading, from the one or more memory devices based at least in part on the command, a write temperature indicative of a temperature of the memory system at a time of writing a subset of the data; and reading, based at least in part on transmitting the write temperature to a host system, one or more subsets of the data.

Aspect 2: The method, apparatus, or non-transitory computer-readable medium of aspect 1, further including operations, features, circuitry, logic, means, or instructions, or any combination thereof for receiving a read command for one or more subsets of the data and transmitting, based at least in part on receiving the read command, an indication that the one or more subsets of the data is unrecoverable at a current temperature of the memory system, where the command to provide write temperature information is received based at least in part on the indication.

Aspect 3: The method, apparatus, or non-transitory computer-readable medium of any of aspects 1 through 2, further including operations, features, circuitry, logic, means, or instructions, or any combination thereof for determining whether a current temperature of the memory system is within a threshold range of the write temperature, where the one or more subsets of the data is read based at least in part on determining that the current temperature of the memory system is within the threshold range of the write temperature.

Aspect 4: The method, apparatus, or non-transitory computer-readable medium of aspect 3, further including operations, features, circuitry, logic, means, or instructions, or any combination thereof for receiving, from the host system, an indication that the host system has adjusted a temperature setting associated with the memory system, where the current temperature is determined based at least in part on the indication.

Aspect 5: The method, apparatus, or non-transitory computer-readable medium of any of aspects 3 through 4, further including operations, features, circuitry, logic, means, or instructions, or any combination thereof for receiving, from the host system, an indication that the current temperature of the memory system is within the threshold range of the write temperature, where determining that the current temperature of the memory system is within the threshold range is based at least in part on the indication.

Aspect 6: The method, apparatus, or non-transitory computer-readable medium of any of aspects 1 through 5, where receive a read command for the one or more subsets of the data based at least in part on transmitting the write temperature, where the one or more subsets of the data is read based at least in part on the read command.

Aspect 7: The method, apparatus, or non-transitory computer-readable medium of aspect 6, further including operations, features, circuitry, logic, means, or instructions, or any combination thereof for determining a first logical address associated with a most-recently written subset of the data and transmitting an indication of the first logical address associated with the most-recently written subset of the data, where the read command is received based at least in part on transmitting the indication.

Aspect 8: The method, apparatus, or non-transitory computer-readable medium of any of aspects 6 through 7, where the data includes black box data received from one or more vehicle sensors and the read command is part of a forensic data recovery procedure to recover the black box data.

Aspect 9: The method, apparatus, or non-transitory computer-readable medium of any of aspects 1 through 8, where the write temperature is associated with a first logical address and the command is associated with a second logical address and the method, apparatuses, and non-transitory computer-readable medium further includes operations, features, circuitry, logic, means, or instructions, or any combination thereof for reading the write temperature from memory cells associated with the first logical address based at least in part on the first logical address satisfying a substitution condition for returning the write temperature to the host system in place of a second write temperature associated with the second logical address.

Aspect 10: The method, apparatus, or non-transitory computer-readable medium of aspect 9, further including operations, features, circuitry, logic, means, or instructions, or any combination thereof for determining whether the second write temperature is unrecoverable, where the write temperature is read based at least in part on determining that the second write temperature is unrecoverable.

Aspect 11: The method, apparatus, or non-transitory computer-readable medium of any of aspects 9 through 10, further including operations, features, circuitry, logic, means, or instructions, or any combination thereof for determining that the first logical address satisfies the substitution condition based at least in part on the first logical address being within a threshold range, index-wise, of the second logical address.

Aspect 12: The method, apparatus, or non-transitory computer-readable medium of any of aspects 9 through 11, further including operations, features, circuitry, logic, means, or instructions, or any combination thereof for determining that the first logical address satisfies the substitution condition based at least in part on a performance level assigned to a first physical address associated with the first logical address.

Aspect 13: The method, apparatus, or non-transitory computer-readable medium of any of aspects 9 through 12, further including operations, features, circuitry, logic, means, or instructions, or any combination thereof for determining that the first logical address satisfies the substitution condition based at least in part on a physical location of memory cells associated with the first logical address.

Aspect 14: The method, apparatus, or non-transitory computer-readable medium of any of aspects 1 through 13, where the command indicates a first logical address and the method, apparatuses, and non-transitory computer-readable medium further includes operations, features, circuitry, logic, means, or instructions, or any combination thereof for determining a table of the one or more memory devices that stores write temperatures representative of average write temperatures for different subsets of the data and reading the write temperature from the table based at least in part on the write temperature being associated with a range of logical addresses that includes the first logical address.

Aspect 15: The method, apparatus, or non-transitory computer-readable medium of aspect 14, further including operations, features, circuitry, logic, means, or instructions, or any combination thereof for writing the subset of the data to the one or more memory devices, where the command to provide the write temperature information is received after writing the subset of the data; determining an average write temperature for the subset of the data based at least in part on writing the subset of the data and based at least in part on a size of the subset of the data satisfying a threshold; and writing the write temperature to the table of the one or more memory devices, where the write temperature includes the average write temperature.

Aspect 16: The method, apparatus, or non-transitory computer-readable medium of any of aspects 1 through 15, where the command is associated with a first logical address and the method, apparatuses, and non-transitory computer-readable medium further includes operations, features, circuitry, logic, means, or instructions, or any combination thereof for determining, based at least in part on the first logical address, a table in the one or more memory devices that stores the write temperature associated with the first logical address, where the write temperature is read from the table.

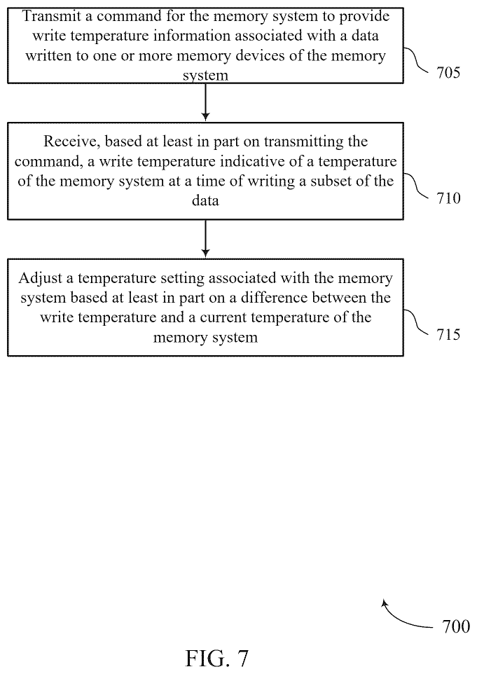

FIG. 7 shows a flowchart illustrating a method 700 that supports write temperature recovery from a memory system in accordance with examples as disclosed herein. The operations of method 700 may be implemented by a host system or its components as described herein. For example, the operations of method 700 may be performed by a host system as described with reference to FIGS. 1 through 3 and 5. In some examples, a host system may execute a set of instructions to control the functional elements of the device to perform the described functions. Additionally, or alternatively, the host system may perform aspects of the described functions using special-purpose hardware.

At 705, the method may include transmitting a command for the memory system to provide write temperature information associated with a data written to one or more memory devices of the memory system. In some examples, aspects of the operations of 705 may be performed by a transmit circuitry 525 as described with reference to FIG. 5.

At 710, the method may include receiving, based at least in part on transmitting the command, a write temperature indicative of a temperature of the memory system at a time of writing a subset of the data. In some examples, aspects of the operations of 710 may be performed by a receive circuitry 530 as described with reference to FIG. 5.

At 715, the method may include adjusting a temperature setting associated with the memory system based at least in part on a difference between the write temperature and a current temperature of the memory system. In some examples, aspects of the operations of 715 may be performed by a controller 535 as described with reference to FIG. 5.

In some examples, an apparatus as described herein may perform a method or methods, such as the method 700. The apparatus may include features, circuitry, logic, means, or instructions (e.g., a non-transitory computer-readable medium storing instructions executable by a processor), or any combination thereof for performing the following aspects of the present disclosure:

Aspect 17: A method, apparatus, or non-transitory computer-readable medium including operations, features, circuitry, logic, means, or instructions, or any combination thereof for transmitting a command for the memory system to provide write temperature information associated with a data written to one or more memory devices of the memory system; receiving, based at least in part on transmitting the command, a write temperature indicative of a temperature of the memory system at a time of writing a subset of the data; and adjusting a temperature setting associated with the memory system based at least in part on a difference between the write temperature and a current temperature of the memory system.

Aspect 18: The method, apparatus, or non-transitory computer-readable medium of aspect 17, further including operations, features, circuitry, logic, means, or instructions, or any combination thereof for receiving one or more subsets of the data based at least in part on receiving the write temperature.

Aspect 19: The method, apparatus, or non-transitory computer-readable medium of aspect 18, further including operations, features, circuitry, logic, means, or instructions, or any combination thereof for transmitting an indication of a threshold temperature associated with the temperature setting, where the one or more subsets of the data is received based at least in part on indication.

Aspect 20: The method, apparatus, or non-transitory computer-readable medium of any of aspects 18 through 19, further including operations, features, circuitry, logic, means, or instructions, or any combination thereof for transmitting an indication that the host system has adjusted the temperature setting associated with the memory system, where the one or more subsets of the data is received based at least in part on the indication.

Aspect 21: The method, apparatus, or non-transitory computer-readable medium of any of aspects 18 through 20, further including operations, features, circuitry, logic, means, or instructions, or any combination thereof for determining, after adjusting the temperature setting, that the current temperature of the memory system is within a threshold range of the write temperature and transmitting a read command for the one or more subsets of the data based at least in part on determining that the current temperature is within the threshold range, where the one or more subsets of the data is received based at least in part on the read command.

Aspect 22: The method, apparatus, or non-transitory computer-readable medium of any of aspects 18 through 21, further including operations, features, circuitry, logic, means, or instructions, or any combination thereof for determining, after adjusting the temperature setting, that the current temperature of the memory system is within a threshold range of the write temperature and transmitting an indication that the current temperature of the memory system is within the threshold range of the write temperature, where the one or more subsets of the data is received based at least in part on the indication.

Aspect 23: The method, apparatus, or non-transitory computer-readable medium of any of aspects 17 through 22, further including operations, features, circuitry, logic, means, or instructions, or any combination thereof for transmitting a read command for one or more subsets of the data and receiving, based at least in part on transmitting the read command, an indication that the one or more subsets of the data is unrecoverable at the current temperature of the memory system, where the command for the memory system to provide write temperature information is transmitted based at least in part on the indication.

Aspect 24: The method, apparatus, or non-transitory computer-readable medium of any of aspects 17 through 23, where the write temperature is associated with a first logical address and the command is associated with a second logical address.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

As used herein, the term “substantially” means that the modified characteristic (e.g., a verb or adjective modified by the term substantially) need not be absolute but is close enough to achieve the advantages of the characteristic.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed and second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed and second condition or action may occur directly as a result of the previous condition or action occurring independent of whether other conditions or actions occur. In some examples, a first condition or action may be performed and second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of these are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices comprising non-volatile memory cells; and
processing circuitry coupled with the one or more memory devices and configured to cause the memory system to:
receive a command to provide write temperature information associated with data written to the one or more memory devices;
read, from the one or more memory devices based at least in part on the command, a write temperature indicative of a temperature of the memory system at a time of writing a subset of the data; and
read, based at least in part on transmitting the write temperature to a host system, one or more subsets of the data.

2. The memory system of claim 1, wherein the processing circuitry is further configured to cause the memory system to:
receive a read command for one or more subsets of the data; and
transmit, based at least in part on receiving the read command, an indication that the one or more subsets of the data is unrecoverable at a current temperature of the memory system, wherein the command to provide write temperature information is received based at least in part on the indication.

3. The memory system of claim 1, wherein the processing circuitry is further configured to cause the memory system to:
determine whether a current temperature of the memory system is within a threshold range of the write temperature, wherein the one or more subsets of the data is read based at least in part on determining that the current temperature of the memory system is within the threshold range of the write temperature.

4. The memory system of claim 3, wherein the processing circuitry is further configured to cause the memory system to:
receive, from the host system, an indication that the host system has adjusted a temperature setting associated with the memory system, wherein the current temperature is determined based at least in part on the indication.

5. The memory system of claim 3, wherein the processing circuitry is further configured to cause the memory system to:
receive, from the host system, an indication that the current temperature of the memory system is within the threshold range of the write temperature, wherein determining that the current temperature of the memory system is within the threshold range is based at least in part on the indication.

6. The memory system of claim 1, wherein the processing circuitry is further configured to cause the memory system to:
receive a read command for the one or more subsets of the data based at least in part on transmitting the write temperature, wherein the one or more subsets of the data is read based at least in part on the read command.

7. The memory system of claim 6, wherein the processing circuitry is configured to cause the memory system to:
determine a first logical address associated with a most-recently written subset of the data; and
transmit an indication of the first logical address associated with the most- recently written subset of the data, wherein the read command is received based at least in part on transmitting the indication.

8. The memory system of claim 6, wherein the data comprises black box data received from one or more vehicle sensors, and wherein the read command is part of a forensic data recovery procedure to recover the black box data.

9. The memory system of claim 1, wherein the write temperature is associated with a first logical address and the command is associated with a second logical address, and wherein the processing circuitry is further configured to cause the memory system to:
read the write temperature from memory cells associated with the first logical address based at least in part on the first logical address satisfying a substitution condition for returning the write temperature to the host system in place of a second write temperature associated with the second logical address.

10. The memory system of claim 9, wherein the processing circuitry is further configured to cause the memory system to:
determine whether the second write temperature is unrecoverable, wherein the write temperature is read based at least in part on determining that the second write temperature is unrecoverable.

11. The memory system of claim 9, wherein the processing circuitry is configured to cause the memory system to:
determine that the first logical address satisfies the substitution condition based at least in part on the first logical address being within a threshold range, index-wise, of the second logical address.

12. The memory system of claim 9, wherein the processing circuitry is configured to cause the memory system to:
determine that the first logical address satisfies the substitution condition based at least in part on a performance level assigned to a first physical address associated with the first logical address.

13. The memory system of claim 9, wherein the processing circuitry is configured to cause the memory system to:
determine that the first logical address satisfies the substitution condition based at least in part on a physical location of memory cells associated with the first logical address.

14. The memory system of claim 1, wherein the command indicates a first logical address, and wherein the processing circuitry is further configured to cause the memory system to:
determine a table of the one or more memory devices that stores write temperatures representative of average write temperatures for different subsets of the data; and
read the write temperature from the table based at least in part on the write temperature being associated with a range of logical addresses that includes the first logical address.

15. The memory system of claim 14, wherein the processing circuitry is further configured to cause the memory system to:
write the subset of the data to the one or more memory devices, wherein the command to provide the write temperature information is received after writing the subset of the data;
determine an average write temperature for the subset of the data based at least in part on writing the subset of the data and based at least in part on a size of the subset of the data satisfying a threshold; and
write the write temperature to the table of the one or more memory devices, wherein the write temperature comprises the average write temperature.

16. The memory system of claim 1, wherein the command is associated with a first logical address, and wherein the processing circuitry is further configured to cause the memory system to:
determine, based at least in part on the first logical address, a table in the one or more memory devices that stores the write temperature associated with the first logical address, wherein the write temperature is read from the table.

17. A host system, comprising:
processing circuitry coupled with a memory system and configured to cause the host system to:
transmit a command for the memory system to provide write temperature information associated with a data written to one or more memory devices of the memory system;
receive, based at least in part on transmitting the command, a write temperature indicative of a temperature of the memory system at a time of writing a subset of the data; and
adjust a temperature setting associated with the memory system based at least in part on a difference between the write temperature and a current temperature of the memory system.

18. The host system of claim 17, wherein the processing circuitry is further configured to cause the host system to:
receive one or more subsets of the data based at least in part on receiving the write temperature.

19. The host system of claim 18, wherein the processing circuitry is further configured to cause the host system to:
transmit an indication of a threshold temperature associated with the temperature setting, wherein the one or more subsets of the data is received based at least in part on indication.

20. The host system of claim 17, wherein the processing circuitry is further configured to cause the host system to:
transmit a read command for one or more subsets of the data; and
receive, based at least in part on transmitting the read command, an indication that the one or more subsets of the data is unrecoverable at the current temperature of the memory system, wherein the command for the memory system to provide write temperature information is transmitted based at least in part on the indication.

21. The host system of claim 18, wherein the processing circuitry is further configured to cause the host system to:
transmit an indication that the host system has adjusted the temperature setting associated with the memory system, wherein the one or more subsets of the data is received based at least in part on the indication.

22. The host system of claim 18, wherein the processing circuitry is further configured to cause the host system to:
determine, after adjusting the temperature setting, that the current temperature of the memory system is within a threshold range of the write temperature; and
transmit a read command for the one or more subsets of the data based at least in part on determining that the current temperature is within the threshold range, wherein the one or more subsets of the data is received based at least in part on the read command.

23. The host system of claim 18, wherein the processing circuitry is further configured to cause the host system to:
determine, after adjusting the temperature setting, that the current temperature of the memory system is within a threshold range of the write temperature; and
transmit an indication that the current temperature of the memory system is within the threshold range of the write temperature, wherein the one or more subsets of the data is received based at least in part on the indication.

24. The host system of claim 17, wherein the write temperature is associated with a first logical address and the command is associated with a second logical address.

25. A method of a memory system, comprising:
receiving a command to provide write temperature information associated with data written to one or more memory devices;
reading, from the one or more memory devices based at least in part on the command, a write temperature indicative of a temperature of the memory system at a time of writing a subset of the data; and
reading, based at least in part on transmitting the write temperature to a host system, one or more subsets of the data.
